(19) United States
(12) Patent Application Publication
(10) Pub. No.: US 2026/0286179 A1
(43) Pub. Date: Sep. 24, 2026

(54) Ceramic Protectant

(71) Applicant: Energizer Auto, Inc., St. Louis, MO (US)

(72) Inventor: Karen Marie Grabiec, Olmsted Township, OH (US)

(73) Assignee: Energizer Auto, Inc., St. Louis, MO (US)

(21) Appl. No.: 19/543,814

(22) Filed: Feb. 18, 2026

Related U.S. Application Data
(60) Provisional application No. 63/776,755, filed on Mar. 24, 2025.

(51) Int. Cl. C09D 183/06; C09D 5/32; C09D 7/20

(52) U.S. Cl. CPC C09D 183/06; C09D 5/32; C09D 7/20

(57) ABSTRACT

The present disclosure describes compositions for providing shine and durability to various surfaces. The compositions of the present disclosure include at least two silicone fluids, one or more silanol-functional siloxane emulsions, one or more cationic amino-functional silicone emulsions, one or more amino-functional siloxanes, one or more mineral oils, one or more rheology modifiers, and one or more diluents; and optionally: one or more hydrocarbon solvents, and/or one or more preservatives.

### CROSS-REFERENCE TO RELATED APPLICATIONS

This application claims the benefit of U.S. Provisional Application No. 63/776,755, filed Mar. 24, 2025, which is incorporated herein by reference in its entirety.

### FIELD OF THE DISCLOSURE

The present disclosure relates to compositions for treating elastomeric surfaces of vehicles to enhance the shine and/or gloss of the surface. More particularly, the compositions for treating elastomeric surfaces are quick drying and provide durable shine and gloss to the surface.

### BACKGROUND OF THE DISCLOSURE

The shine and glossy appearance of a vehicle is an important characteristic because it indicates a clean, new, and/or well-maintained vehicle, which can significantly increase the vehicle's aesthetic appeal and value. Elastomeric surfaces, such as tires, trim, and plastic components on the exterior of a vehicle, however, tend to lose their shine and glossy appearance rapidly over time due to contaminants, such as dirt, break dust, oil/grease, and road salt, and the degradation, oxidation, and fading of the materials from environmental conditions, such as rain, ultraviolet (UV) radiation and extreme cold and/or heat. Contaminants also present maintenance and durability concerns as they can also contribute to the deterioration of a surface and the development of scratches. Despite these problems, contaminants and deterioration often do not justify the replacement or re-painting of a surface, which are both very costly to consumers. Therefore, there is a need for products that can protect a vehicle's exterior surfaces by creating a protective barrier against contaminants, scratches, and environmental elements. There is also a considerable market for products that can effectively restore the shine and glossy appearance of exterior plastic and rubber components of vehicles.

Consumers often turn to silicone products which can provide a protective coating for vehicle surfaces, repel contaminants, protect against environmental damage, preserve the vehicles appearance, and make it easier to clean the surface of contaminants. Silicone based products can also enhance a vehicle's gloss and shine to improve its appearance. While such compositions for protecting surfaces and improving gloss and shine are available, these formulas/products often have a short lifespan and low durability, requiring frequent reapplication, are difficult to apply evenly and without streaks, contain low-quality ingredients that do not provide sufficient protection against scratches. Low-quality formulations and applicators may also contain abrasives that can damage the surfaces if not used correctly. Because of such deficiencies, there is a need for improved compositions, applicators, and methods for protecting surfaces, repelling contaminants, and enhancing the overall aesthetic appearance of a vehicle by providing a deep, dark finish to tires, trim, and plastic surfaces.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes compositions for treating surfaces, including elastomeric surfaces of vehicles to enhance the shine and/or gloss of the surface, and methods of preparing the compositions described herein. More particularly, the compositions for treating elastomeric surfaces are quick drying and provide durable shine and gloss to the surface. In embodiments, the compositions can also clean the surfaces.

The compositions described herein include at least two silicone fluids: a first silicone fluid and a second silicone fluid; one or more silanol-functional siloxane emulsions; one or more cationic amino-functional silicone emulsions; one or more amino-functional siloxanes; one or more mineral oils; one or more rheology modifiers; and one or more diluents; and optionally, the compositions include one or more hydrocarbon solvents; and/or one or more preservatives.

A method of protecting a surface, wherein the method includes applying a composition of the present disclosure to a surface, for example a plastic, glass, vinyl, or rubber surface, such as the surface of a vehicle.

A kit including a composition of the present disclosure and an applicator for applying composition to a surface.

### BRIEF DESCRIPTION OF THE DRAWINGS

FIG. 1 shows gloss units (GU) before and after application of Example Composition 1 on rubber, tire, and plastic. Rubber took readings at 60° and the Tire and Plastic substrates readings are at 85°

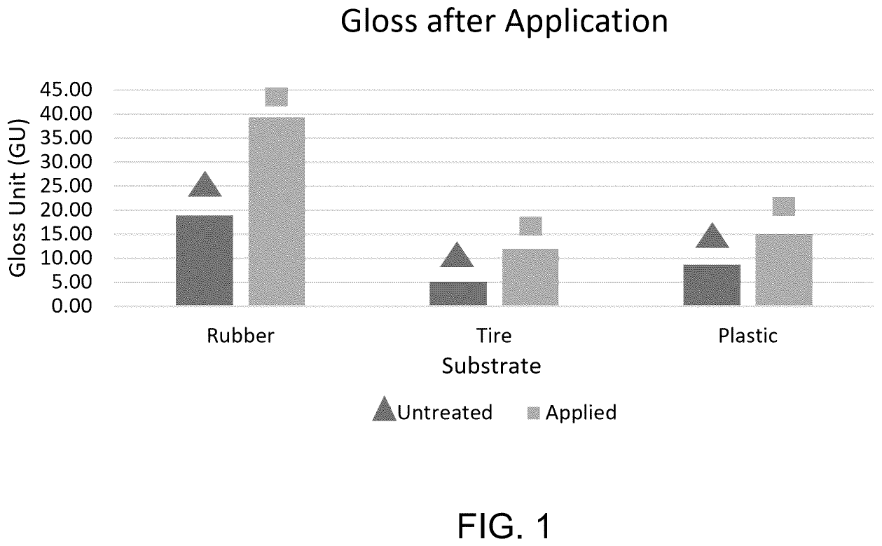

FIG. 2 shows color (L-value) before and after application of Example Composition 1 on rubber, tire, and plastic. L-value is the blackness of the color. When an L-value comes nearer 0, it is getting darker. The application of product gave the substrate more color depth and darkening of color.

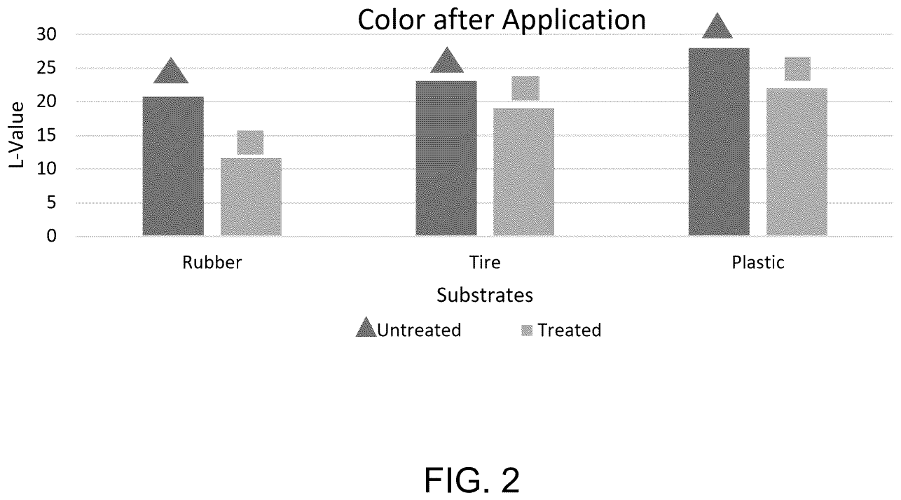

FIG. 3 shows contact angle difference from untreated to treated samples on plastic trim and rubber substrates. The samples were treated with Example Composition 1. The increased contact angle means increased hydrophobicity on the surface. A more hydrophobic surface means more repellency and protection for the surface.

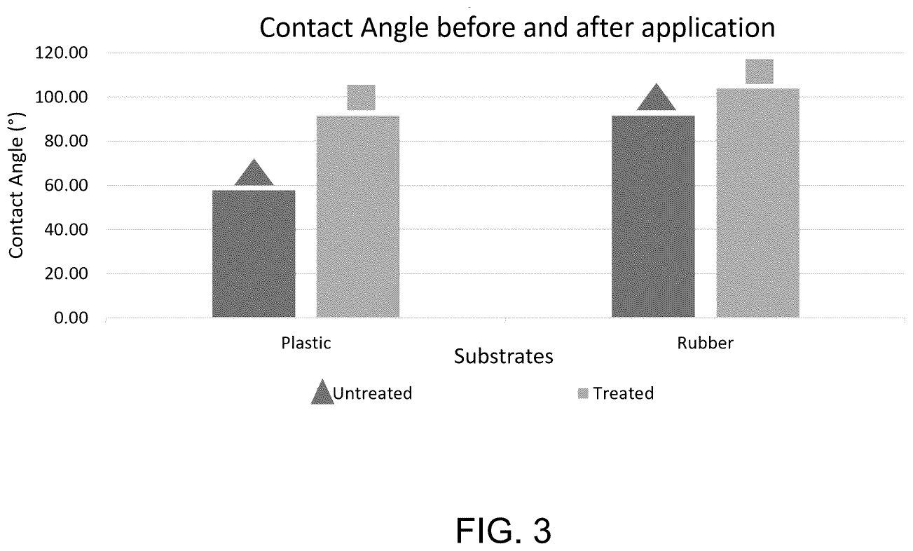

FIG. 4 shows product performance on plastics. Various trims that have the Example Composition (Example Composition 1 (Ex. Comp. 1) and Competitors 1-4) applied on the left side of the substrate vs the right which is untreated.

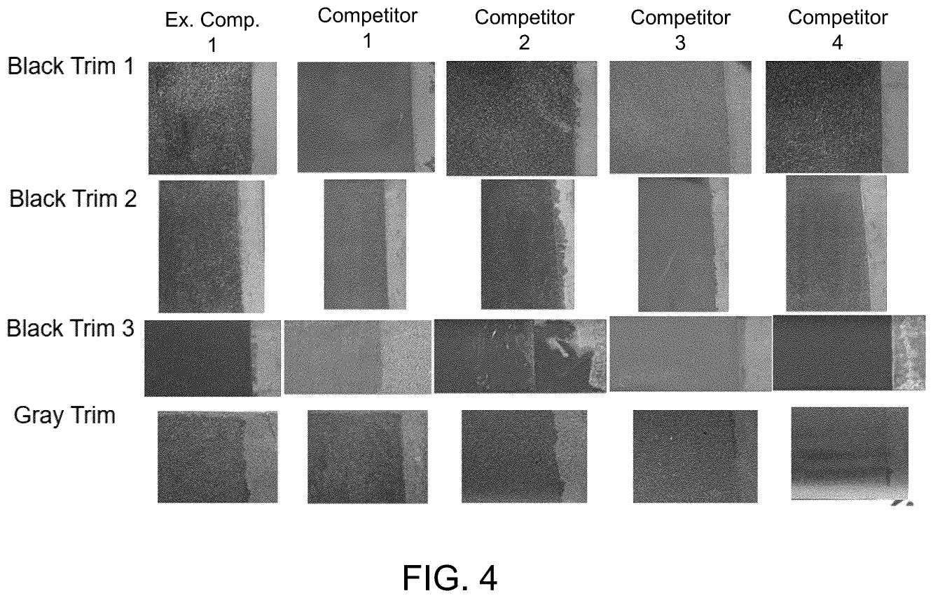

FIG. 5 shows durability on plastic during car wash. Trim from a vehicle that has the Example Composition (Ex. Comp. 1 and Competitors 2 and 5-7) applied on the right side of the surface vs the left side which is untreated. The top photo is after application but before any snow foam washes. The middle photo is after 6 washes and the bottom photo is the surface after 12 washes.

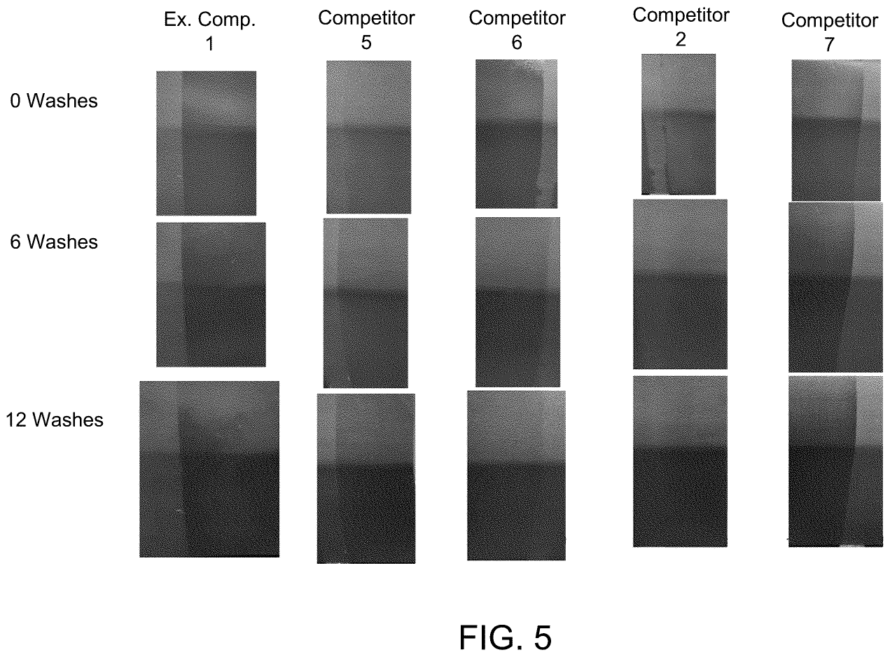

FIG. 6 shows the performance of the Example Composition on rubber & tire. Tire samples that have product (Ex. Comp. 1 and Competitors 2 and 5-7) applied on the right side of the substrate vs the left which is untreated. Rubber samples with product (Ex. Comp. 1 and Competitors 2 and 5-7) applied on the bottle half of the sample vs the untreated top.

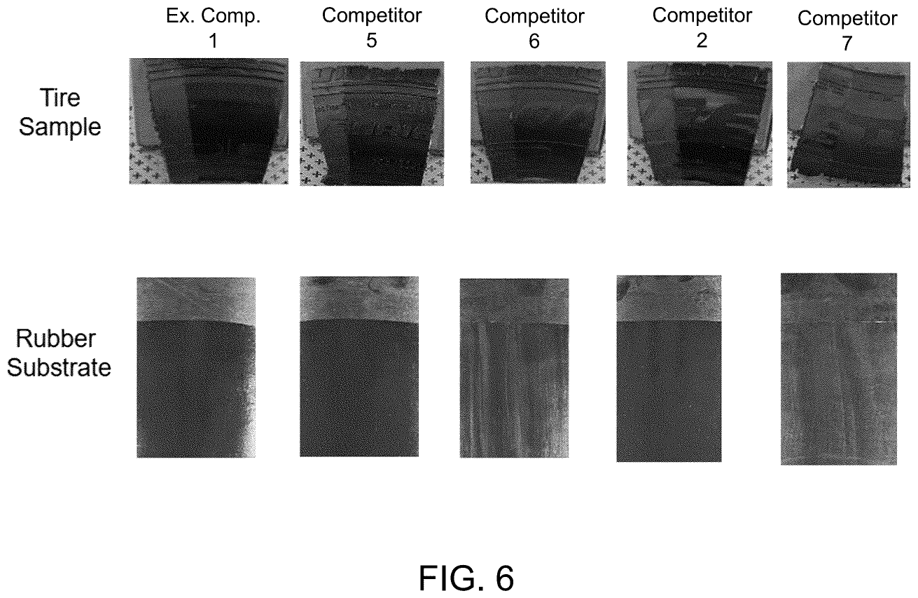

FIG. 7 shows durability on tires during car wash. Tire from a vehicle that has the Example Composition (Ex. Comp. 1 and Competitors 2 and 5-7) applied on one side of the surface vs the other side which is untreated. The top photo is after application but before any snow foam washes. The middle photo is after 3 washes and the bottom photo is the surface after 6 washes.

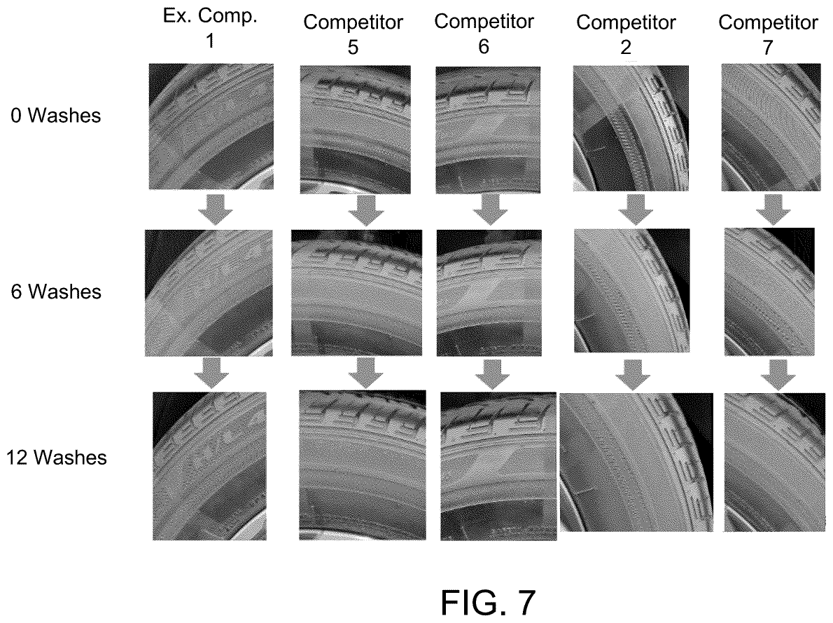

FIGS. 8A-8D show untreated and treated plastic surfaces. The plastic surfaces are treated with Example Composition 1. Example Composition 1 is applied to multiple plastic areas on a car; trim (FIG. 8A and FIG. 8B), bumper (FIG. 8C), window trim (FIG. 8D).

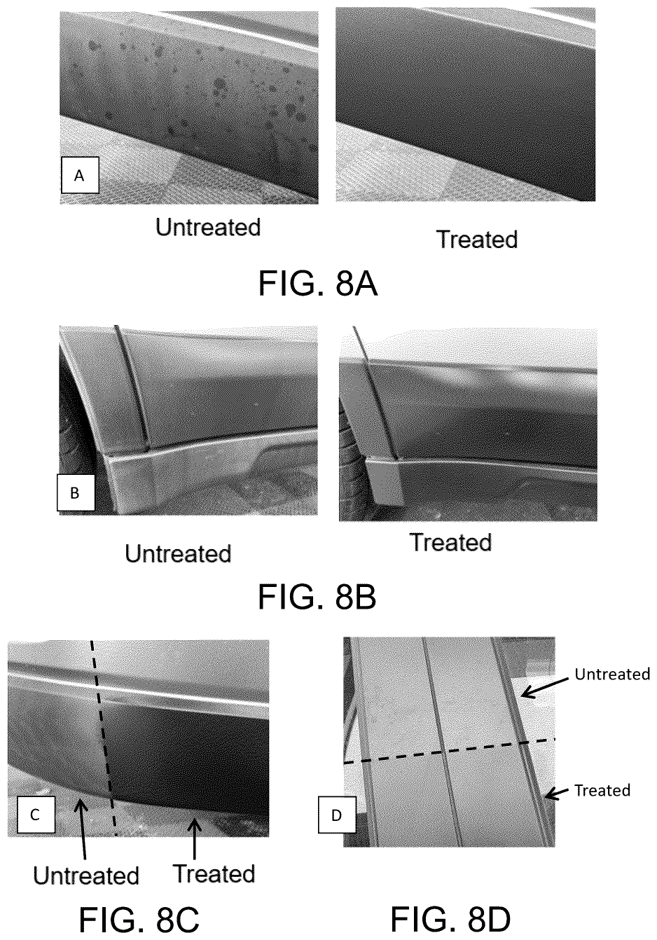

FIG. 9 shows untreated and treated tire surfaces. The tire surfaces are treated with Example Composition 1. Example Composition 1 applied to multiple Tire areas on a car tire and tire sample.

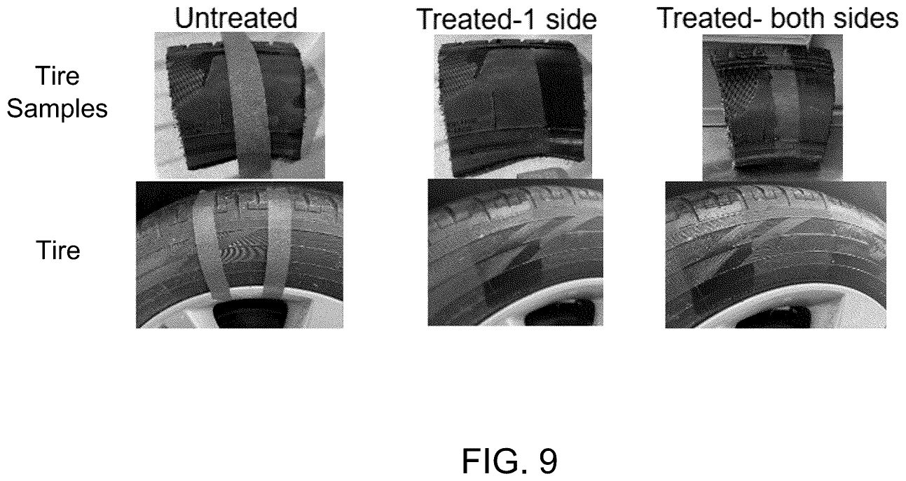

### DETAILED DESCRIPTION

Compositions described herein provide shine and protection to external surfaces of a vehicle, for example plastic and tire surfaces. The vehicle can include a car, truck, boat, and recreational vehicle (RV). Plastic surfaces can entail bumpers, rocker panels, vehicle, and door trim weatherstripping cover and mirror backings. Compositions described herein are safe on surrounding surfaces as well, including glass, paint, wheels, headlights, mirror, and vinyl. The compositions can be used on vinyl surfaces, for example in areas slippery surfaces are not a concern. In embodiments, the compositions provide a white lotion/gel formula with a viscosity between 7000 cPs and 12,500 cPs.

The compositions described herein can restore deep, black shine on tire and plastic surfaces. The compositions also provide a protective coating to shield the surface from environmental elements. For example, the compositions can provide protection against UV damage, oxidation, road grime, and other contaminants. Methods described herein provide for the compositions to be applied in even layers that quickly dry, for fast drying, no smear coverage. The compositions can also provide buildable shine and protection. The compositions can be applied in multiple layers for desired shine and protection. The compositions provide durable shine and protection, for example for one year for plastic surfaces and for six months for tires, based on the average number of touchless/snow foam car washes per year (1 wash/month=12 washes/year).

In embodiments, the present disclosure provides a kit including one or more of the compositions described herein, an application tool, and/or a reusable sponge.

The compositions described herein include components, such as at least two silicone fluids: a first silicone fluid and a second silicone fluid; one or more silanol-functional siloxane emulsions; one or more cationic amino-functional silicone emulsions; one or more amino-functional siloxanes; one or more mineral oils; one or more rheology modifiers; and one or more diluents; and optionally, the compositions include one or more hydrocarbon solvents; and/or one or more preservatives.

In embodiments, the compositions described herein include one or more diluents, one or more rheology modifiers, one or more mineral oils, one or more amino-functional siloxanes, one or more cationic amino-functional silicone emulsions, one or more silanol-functional siloxane emulsions, and at least two silicone fluids; and optionally, one or more hydrocarbon solvents, and/or a preservative.

The diluent can include water. The water can include purified water such as deionized (DI) water, distilled water, and/or reverse osmosis (RO) water. In embodiments, the composition includes by total weight of the composition 75 wt % to 95 wt %, 78 wt % to 90 wt %, 80% to 85 wt %, or 80.15 wt % of one or more diluents.

The one or more hydrocarbon solvents can include hydrotreated light petroleum distillates, alcohol hydrocarbon solvents, or a combination thereof. The one or more hydrocarbon solvents can include hydrotreated isoparaffins and naphthenics. The one or more hydrocarbon solvents can include hydrotreated light petroleum distillates having a flash point of 170° F. or 210° F. For example, the one or more hydrocarbon solvents can include LPA 210 and/or LPA 170. In embodiments, the composition includes by total weight of the composition 0.5 wt % to 5 wt %, 0.75 wt % to 3 wt %, 1 wt % to 2 wt %, or 1.50 wt % of the one or more hydrocarbon solvents

The one or more rheology modifiers can include acrylate and acrylamide copolymers. For example, the one or more rheology modifiers can include NOVEMER EC-1 polymer and a synthetic HASE (hydrophobically modified alkali swellable emulsion) rheology modifier, such as ACUSOL 801S. In embodiments, the composition includes by total weight of the composition 0.5 wt % to 5 wt %, 0.75 wt % to 3 wt %, 1.0 wt % to 2 wt %, or 1.25 wt % of the one or more rheology modifiers.

The one or more mineral oils can include mineral synthetic oil and/or mineral oil obtained from petrochemicals. For example, the one or more mineral oils can include a white mineral oil such as SEMTOL 500 and/or PAROL 500 HP. In embodiments, the composition includes by total weight of the composition 0.1 wt % to 5 wt %, 0.5 wt % to 3 wt %, 0.75 wt % to 2 wt %, or 1.00 wt % of the one or more mineral oils.

The one or more amino-functional siloxanes can include an amino-functional polydimethylsiloxane. In embodiments, the amino-functional polydimethylsiloxane is amodimethicone. For example, the one or more amino-functional siloxanes can include SILTECH E-4135, which contributes to the formation of a ceramic coating. In embodiments, the composition includes by total weight of the composition 0.1 wt % to 1.0 wt %, 0.2 wt % to 0.8 wt %, 0.25 wt % to 0.5 wt %, or 0.30 wt % of one or more amino-functional siloxanes.

The one or more cationic amino-functional silicone emulsions can include an amino-functional silicone polymer, such as di-Me, polymers with 3-[(2-aminoethyl)amino]propyl silsesquioxanes, hydroxy-terminated. For example, the cationic amino-functional silicone polymer can include XIAMETER MEM-8035, DOW CORNING 949 (XIAMETER MEM-0949), EMULSIL CC-30, WACKER L 656, or combinations thereof. In embodiments, the composition includes by total weight of the composition 1.0 wt % to 5 wt %, 1.5 wt % to 3 wt %, or 2 wt % of one or more cationic amino-functional silicone emulsions.

The one or more silanol-functional siloxane emulsions can include a silanol-functional siloxane polymer, such as a polydimethylsiloxane polymer. Examples of the one or more silanol-functional siloxane emulsions can include a high molecular weight silanol-functional siloxane polymer such as DOWSIL HV 496 Emulsion. In embodiments, the composition includes by total weight of the composition 1 wt % to 5 wt %, 1.5 wt % to 3 wt %, or 2 wt % of one or more silanol-functional siloxane emulsions.

The at least two silicone fluids can include silicone fluids having a viscosity of 350 centistokes (cSt) to 20,000 cSt. For example, the first silicone fluid can have a viscosity of 100 centistokes (cSt) to 1,500 cSt, 200 cSt to 1,200 cSt, 300 cSt to 1,200 cSt, 500 cSt to 1,200 cSt, 700 cSt to 1,200 cSt, or 900 cSt to 1,100 dSt and the second silicone fluid can have a viscosity of 10,000 cSt to 15,000 cSt, 11,000 cSt to 14,500 cSt, 11,500 cSt to 14,000 cSt, or 12,000 cSt to 13,000 cSt. In embodiments, the first silicone fluid has a viscosity of 1,000 cSt and the second silicone fluid has a viscosity of 12,500 cSt. The at least two silicone fluids can include silicone oils having the formula: RₙSiO_{(4-n)/2)m}, wherein n is 0 to 3, m is 2 or greater, and R is alkyl, alkylene, allyl, aryl, benzyl, phenyl, amine, amide, vinyl, fluoroalkyl, perfluoroalkane, carboxyester, or quaternary alkyl ammonium. The at least two silicone fluids can include silicone oils including polydialkylsiloxanes, such as polydimethylsiloxanes. The compositions can include ELEMENT14 PDMS 12.5K, XIAMETER PMX-200 Silicone Fluid 12,500 cSt, and/or XIAMETER PMX-200 Silicone Fluid 1000 cSt. In embodiments, the composition includes a first silicone fluid including XIAMETER PMX-200 Silicone Fluid 1000 cSt and a second silicone fluid including ELEMENT14 PDMS 12.5K or XIAMETER PMX-200 Silicone Fluid 12,500 cSt. The composition can include by total weight of the composition 1 wt % to 20 wt %, 5 wt % to 18 wt %, 7 wt % to 15 wt %, 10 wt % to 12 wt %, or 11.58 wt % of the at least two silicone fluids. In embodiments, the composition includes by total weight of the composition at least 2.0 wt % to 6.0 wt % of the first silicone fluid and at least 5 wt % to 9.0 wt % of the second silicone fluid, or 4.00 wt % of the first silicone fluid and 7.58 wt % of the second silicone fluid.

The one or more preservatives include dimethyl-dimethyl hydantoin (DMDMH), benzisothiazolinone (BIT), methylisothiazolinone (MIT), or methylchloroisothiazolinone (CMIT), iodopropyl butylcarbamate, or combinations thereof. In embodiments, the one or more preservatives includes BIT. For example, the one or more preservatives can include TROYGUARD BC11 (1,2-Benisothiazol-3 (2H)-one (BIT), 5-chloro-2-methyl-4-isothiazolin-3-one (CMIT), and 2-methyl-2H-isothiazol-3-one (MIT)), DANTOGARD Plus liquid (DMDM Hydantoin and Iodopropnyl Butylcarbamate), or ACTICIDE B20 (BIT). In embodiments, the composition includes by total weight of the composition 0.01 wt % to 0.5 wt %, 0.05 wt % to 0.4 wt %, 0.10 wt % to 0.3 wt %, or 0.22 wt % of one or more preservatives.

The compositions of the present disclosure can include: a silicone fluid of 1,000 cSt; a silicone fluid of 12,500 cSt; a high molecular weight silanol-functional siloxane polymer emulsion;

a cationic amino-functional emulsion including di-Me, polymers with 3-[(2-aminoethyl)amino]propyl silsesquioxanes, hydroxy-terminated; amodimethicone; mineral oil obtained from petrochemicals; acrylate and acrylamide copolymers; a mixture of hydrotreated isoparaffins and naphthenics; water; and a preservative including BIT.

In embodiments, a composition of the present disclosure includes by total weight of the composition: 4.00 wt % of a silicone fluid of 1,000 cSt; 7.58 wt % of a silicone fluid of 12,500 cSt; 2.00 wt % of a high molecular weight silanol-functional siloxane polymer emulsion; 2.00 wt % of a cationic amino-functional emulsion including di-Me, polymers with 3-[(2-aminoethyl)amino]propyl silsesquioxanes, hydroxy-terminated; 0.30 wt % of amodimethicone; 1.00 wt % mineral oil obtained from petrochemicals; 1.25 wt % of acrylate and acrylamide copolymers; 1.50 wt % of a mixture of hydrotreated isoparaffins and naphthenics; 80.15 wt % of water; and 0.22 wt % of a preservative including BIT.

The compositions described herein can include quality characteristics such as: a pH in a range of 6.5 to 8, for example 7; a viscosity in a range of 7,000 cPs to 12,000 cPs, for example 7,700 cPs; a density in a range of 0.985 g/mL to 1.050 g/mL, for example 0.992 g/mL; and percent solids in a range of 14.25% to 16.0%, for example 15.2%.

In embodiments, each of the components of the compositions described herein can be a substance including a main ingredient or a mixture including a main ingredient and other ingredients, such as water and other solvents. In some cases, a substance used herein may include a small amount of impurities. In some cases, a mixture used herein may also include small amounts of impurities, and/or other ingredients in unreportable levels. For example, DOWSIL HV 496 Emulsion can include polydimethylsiloxane polymer as the main ingredient, and 0.6-5.6 wt % of triethanolamine dodecylbenzene sulfonate, and 2.0-2.5 wt % of Isotridecanol, ethoxylated. DOWSIL HV 496 Emulsion is a water based mixture and can include solids up to 38-42 wt %. XIAMETER MEM-8035 can include Siloxanes and Silicones, di-Me, polymers with 3-[(2-aminoethyl)amino]propyl silsesquioxanes, hydroxy-terminated as the main ingredient (23-35 wt %), and 1.9-2.5 wt % Octamethyl Cyclotetrasiloxane, 1.6-2.2 wt % Ethoxylated branched C11-14, C13-rich Alcohols, 1.5-2.1 wt % Hexadecyltrimethyl ammonium chloride, and 1.4-1.8 wt % decamethylcyclopentasiloxane. DOW CORNING 949 (XIAMETER MEM-0949) can include polyoxyethylated, C11-14 alcohols and cetrimonium chloride. EMULSIL CC-30 can include amodimethicone, trideceth-12, and cetrimonium chloride. WACKER L 656 can include poly [3-((2-aminoethyl)amino)propyl]methyl(dimethyl)siloxane, methoxy-terminated, aminoalkyl polydimethylsiloxane, and octamethyl cyclotetrasiloxane. SILTECH E-4135 can include amodimethicone as the main ingredient (20-35 wt %), 10-15 wt % Polyethylene glycol mono (3,5-dimethyl-1-isobutylhexyl) ether, and up to 35 wt % solids content. NOVEMER EC-1 can include acrylate and acrylamide copolymers as the main ingredient (26-28 wt %), 22-24 wt % mineral oil, and 1-3 wt % a non-ionic surfactant, emulsifier, and stabilizer (e.g., Polysorbate-85). ACUSOL 801S can include 19-21% of an acrylic polymer and 79-81% water. TROYGUARD BC-11 can include benzothiazole-3 (2h)-one (BIT) (10.1 wt %) as the main ingredient, and 5-chloro-2-methyl-4-isothiazolin-3-one (CMIT) (0.5 wt %), and 2-methyl-2H-isothiazol-3-one (MIT) (0.16 wt %). DANTOGARD Plus liquid can include DMDM Hydantoin (70.0%), Iodopropnyl Butylcarbamate (2.50%), and Butane-1,3-diol (4.50%). ACTICIDE B20 can include 1,2-Benzisothiazolin-3-one (BIT) (20 wt %) as the main ingredient and inert ingredients, including sodium hydroxide (less than 5%), to make up 80 wt %.

The present disclosure describes methods of preparing the compositions described herein. In embodiments, methods of preparing a composition of the present disclosure can include adding one or more hydrocarbon solvents to one or more diluents that are mixing in a container to form a homogeneous solution. One or more rheology modifiers can be added to the solution and then mixed until the solution is homogeneous. One or more amino functional siloxanes can be added to the solution and then mixed until the solution is homogeneous. If included, the one or more preservatives can be added to the solution and then mixed until the solution is homogeneous. One or more mineral oils and at least two silicone fluids can be added (simultaneously or sequentially) to the solution and then mixed until the solution is homogeneous. The one or more mineral oils and the at least two silicone fluids can be added simultaneously or sequentially. One or more cationic amino-functional emulsions and one or more silanol-functional siloxane emulsions can be added to the solution (simultaneously or sequentially) and then the solution can be mixed until homogeneous, thereby obtaining the composition.

In embodiments, compositions can be prepared in a batch (“batching”) process. Tanks, raw material transfer/holding containers, pumps, holding tank, and piping to the filler can be completely sanitized before each batch. Blending raw materials to form a composition of the present disclosure can include adding a specified amount of diluent (e.g., Deionized Water) to a mixing tank having at least one agitator. In embodiments, the specified amount of water can be enough to cover all impellers of the agitator. In embodiments, the specified amount of water used to fill the mixing tank can be used to calculate wt % values of the remaining ingredients to add to the mixing tank. In embodiments, agitation throughout the batching process should be enough to impart significant fluid movement, without excessive air entrainment.

After the specified amount of water is added to the mixing tank, the one or more hydrocarbon solvents can be added to the diluent in the mixing tank, and the solution can be mixed until homogeneous, for example 10 minutes. Next, the one or more rheology modifiers can be added to the mixing tank, and the solution can be mixed until homogeneous, for example a minimum of 45 minutes. In embodiments, the agitation speed can be adjusted as needed to achieve a fluid vortex of the solution with minimal splashing. Next, the one or more amino-functional siloxanes can be added to the mixing tank, and the solution can be mixed, for example for 30 minutes and adjusting agitation speed as needed to form a fluid vortex with minimal splashing. If included, the one or more preservatives can then be added to the mixing tank, and the solution can be mixed, for example adjusting agitation speed as needed to form a vortex with minimal splashing. Next, the one or more mineral oils and the at least two silicone fluids, for example silicone oils (Silicone 12,500 cSt and Silicone 1000 cSt), can be added to the mixture. The mixture can then be mixed until homogeneous, for example 60 minutes, adjusting agitation speed as needed to form a vortex with minimal splashing. Finally, the one or more silicone emulsions (e.g., DOWSIL HV 496 and XIAMETER MEM-8035) can be added to the mixture and then mixed until homogenous, for example 60 minutes, adjusting agitation speed as needed.

In embodiments, compositions obtained by the methods described herein can then be stored, packaged, and/or used. For example, compositions can be dispensed and packaged into 12 oz or 16 oz plastic bottles. Packaged compositions of the present disclosure can be sold to consumers.

The present disclosure describes methods of protecting a surface, wherein the method includes applying a composition of the present disclosure to a surface. In embodiments, the surface includes plastic, glass, vinyl, and rubber, such as a surface of a vehicle. Examples of vehicles include automobiles, motorcycles, buses, trains, watercrafts including ships and boats, aircrafts including planes and helicopters, and spacecrafts. For example, the surface can be the surface of a bumper, rocker panel, weatherstripping cover, plastic backing of mirror, wheel, headlight, vinyl covers for vehicles, spare tire covers, or trims of door, wheel, and tailgate.

In embodiments, methods of using the compositions described herein can include ensuring surface is clean and cool before use. Before dispensing, the composition can be shaken and/or mixed well. The composition can then be applied to an applicator, for example a microfiber cloth or sponge applicator, and spread evenly onto a surface, such as a tire or plastic surface. Excess product may be wiped off of the surface after application. In some cases, results can be improved by applying multiple layers of the composition to the surface to build protection and shine. For example, allow at least 5 minutes of dry-time in between applications.

The present disclosure also includes kits that includes one or more composition described herein and an applicator, such as a sponge applicator or microfiber cloth, for applying composition to a surface. In embodiments, methods of using the composition and an application kit described herein can include ensuring surface is clean and cool before use. Before dispensing, the composition can be shaken and/or mixed well. The composition can then be applied to the applicator supplied with the kit and spread evenly onto a surface, such as a tire or plastic surface. Excess product may be wiped off of the surface after application. The results can be improved by applying multiple layers of the composition to the surface to build protection and shine. For example, allow at least 5 minutes of dry-time in between applications. In embodiments, the applicator provided with the kit includes a reusable sponge and/or microfiber cloth. For example, the sponge/microfiber cloth can be removed from the body of the applicator by gently squeezing the edges to release it from the applicator. In implementations, the sponge and/or microfiber cloth used to apply the composition to the surface can be reused by rinsing with water to clean and remove any formula from the sponge and allowing to air-dry for future use.

The compositions and methods of the present disclosure provides durable long lasting protection of a surface. In embodiments, a coating of a composition of the present disclosure can remain on a surface for 1 to 15 washes, 3 to 15 washes, 6 to 12 washes, 8 to 13 washes, or 10 to 13 washes. In some cases, a coating of a composition of the present disclosure can remain on a surface for 3 to 24 months, 3 to 18 months, 3 to 15 months, 6 to 15 months, or 6 to 12 months. In embodiments, a coating of a composition of the present disclosure can protect a surface from ultraviolet radiation.

The compositions and methods of the present disclosure can provide improved appearance and water repellancy of a surface. For example, a coating of a composition of the present disclosure can provide a surface with a higher gloss value, lower color depth value, and/or a higher contact angle (water repellancy) than a surface that has not been applied with the composition.

The terms “composition(s)” and “formulation(s)” are used interchangeably to refer to the compositions described herein.

The term “wt %” or “%” in the context of the weight of the component in the composition are used interchangeably to be relative to the total weight of the composition.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients or components and to those that do not materially affect the embodiment. As used herein, a material effect would cause a statistically significant difference in the performance of the composition, for example, for providing shine, deep black color, and/or protection, such as from oxidation, UV radiation, water, dirt, and/or grime, to a surface.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The Exemplary Embodiments and Example below are included to demonstrate particular claims of the disclosure. Those of ordinary skill in the art should recognize in light of the present disclosure that many changes can be made to the specific claims disclosed herein and still obtain a like or similar result without departing from the spirit and scope of the disclosure.

### EXEMPLARY EMBODIMENTS

The following are exemplary embodiments:
1. A composition including:
   at least two silicone fluids: a first silicone fluid and a second silicone fluid;
   one or more silanol-functional siloxane emulsions;
   one or more cationic amino-functional silicone emulsions;
   one or more amino-functional siloxanes;
   one or more mineral oils;
   one or more rheology modifiers; and
   one or more diluents; and
   optionally:
      one or more hydrocarbon solvents; and/or
      one or more preservatives.
2. The composition of embodiment 1, wherein the composition includes by total weight of the composition:
   about 1% to 20% of the at least two silicone fluids;
   about 1.0% to 5% of one or more silanol-functional siloxane emulsions;
   about 1.0% to 5% of one or more cationic amino-functional silicone emulsions;
   about 0.1% to 1.0% of one or more amino-functional siloxanes;
   about 0.1% to 5% of the one or more mineral oils;
   about 0.5% to 5% of the one or more rheology modifiers; and
   about 75% to 95% of one or more diluents; and
   optionally:
      about 0.5% to 5% of the one or more hydrocarbon solvents; and/or
      about 0.01% to 0.5% of the one or more preservatives.
3. The composition of embodiment 1 or 2, wherein the composition includes by total weight of the composition:
   about 4.00% of a first silicone fluid;
   about 7.58% of a second silicone fluid;
   about 2.00% of one or more silanol-functional siloxane emulsions;
   about 2.00% of one or more cationic amino-functional silicone emulsions;
   about 0.30% of one or more amino-functional siloxanes;
   about 1.00% of the one or more mineral oils;
   about 80.15% of one or more diluents;
   about 1.25% of the one or more rheology modifiers;
   about 1.5% of the one or more hydrocarbon solvents; and
   about 0.22% of the one or more preservatives.
4. The composition of embodiment 1 or 2, wherein the composition includes by total weight of the composition: about at least 2.0% to 6.0% of the first silicone fluid and about at least 5% to 9.0% of the second silicone fluid.
5. The composition of any one of embodiments 1-4, wherein the first silicone fluid has a viscosity of about 100 centistokes (cSt) to 1,500 cSt, 200 cSt to 1,200 cSt, 300 cSt to 1,200 cSt, or 300 cSt to 1,100 cSt, and the second silicone fluid has a viscosity of about 10,000 cSt to 15,000 cSt, 11,000 cSt to 14,500 cSt, 11,500 cSt to 14,000 cSt, or 12,000 cSt to 13,000 cSt.
6. The composition of any one of embodiments 1-5, wherein the first silicone fluid has a viscosity of about 1,000 cSt and the second silicone fluid has a viscosity of about 12,500 cSt.
7. The composition of any one of embodiments 1-6, wherein the at least two silicone fluids include silicone oils having the formula:

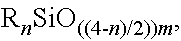

wherein:
   n is 0 to 3;
   m is 2 or greater; and
   R is alkyl, alkylene, allyl, aryl, benzyl, phenyl, amine, amide, vinyl, fluoroalkyl, perfluoroalkane, carboxyester, or quaternary alkyl ammonium.
8. The composition of any one of embodiments 1-7, wherein the at least two silicone fluids include silicone oils including polydialkylsiloxanes; and optionally wherein the polydialkylsiloxanes include polydimethylsiloxanes.
9. The composition of any one of embodiments 1-8, wherein the one or more silanol-functional siloxane emulsions include a silanol-functional siloxane polymer, and optionally wherein the silanol-functional siloxane polymer is a high molecular weight polymer.
10. The composition of any one of embodiments 1-9, wherein the one or more cationic amino-functional silicone emulsions include an amino-functional silicone polymer, and optionally, wherein the amino-functional silicone polymer includes di-Me, polymers with 3-[(2-aminoethyl)amino]propyl silsesquioxanes, hydroxy-terminated.
11. The composition of any one of embodiments 1-10, wherein the one or more amino-functional siloxanes includes an amino-functional polydimethylsiloxane, and optionally, wherein the amino-functional polydimethylsiloxane is amodimethicone.
12. The composition of any one of embodiments 1-11, wherein the one or more mineral oils include mineral synthetic oil and/or mineral oil obtained from petrochemicals.
13. The composition of any one of embodiments 1-12, wherein the one or more rheology modifiers include acrylate and acrylamide copolymers.
14. The composition of any one of embodiments 1-13, wherein the one or more hydrocarbon solvents include hydrotreated light petroleum distillates, alcohol hydrocarbon solvents, or a combination thereof.
15. The composition of any one of embodiments 1-14, wherein the one or more hydrocarbon solvents include hydrotreated isoparaffins and naphthenics.
16. The compositions of any one of embodiments 1-15, wherein the one or more diluents include water, and optionally wherein the water is distilled water, deionized water, or reverse osmosis water.
17. The composition of any one of embodiments 1-16, wherein the one or more preservatives include dimethyl-dimethyl hydantoin (DMDMH), benzisothiazolinone (BIT), methylisothiazolinone (MIT), or methylchloroisothiazolinone (CMIT), iodopropnyl butylcarbamate, or a combination thereof.
18. The composition of any one of embodiments 1-17, wherein the one or more preservatives includes BIT.
19. The composition of any one of embodiments 1-18, wherein the composition includes: silicone fluid of about 1,000 cSt; silicone fluid of about 12,500 cSt; high molecular weight silanol-functional siloxane polymer emulsion; a cationic amino-functional emulsion including di-Me, polymers with 3-[(2-aminoethyl)amino]propyl silsesquioxanes, hydroxy-terminated; amodimethicone; mineral oil obtained from petrochemicals; acrylate and acrylamide copolymers; and water; and optionally: a mixture of hydrotreated isoparaffins and naphthenics; and/or a preservative including BIT.
20. The composition of any one of embodiments 1-19, wherein the composition includes by total weight of the composition:
   about 4.00% of a silicone fluid of about 1,000 cSt;
   about 7.58% of a silicone fluid of about 12,500 cSt;
   about 2.0% of a high molecular weight silanol-functional siloxane polymer emulsion;
   about 2.0% of a cationic amino-functional emulsion including di-Me, polymers with 3 [(2-aminoethyl)amino]propyl silsesquioxanes, hydroxy-terminated;
   about 0.3% of amodimethicone;
   about 1.0% of mineral oil obtained from petrochemicals;
   about 80.15% of water;
   about 1.25% of acrylate and acrylamide copolymers;
   about 1.5% of a mixture of hydrotreated isoparaffins and naphthenics; and
   about 0.22% of preservative including BIT.
21. A method of preparing the composition of any one of embodiments 1-20, wherein the method includes:
   (i) adding one or more hydrocarbon solvents to the one or more diluents that is mixing in a container to form a homogeneous solution;
   (ii) adding one or more rheology modifiers to the solution and mixing until homogeneous;
   (iii) adding one or more amino functional siloxanes and mixing;
   (iv) adding one or more preservatives and mixing;
   (v) adding one or more mineral oils and the at least two silicone fluids and mixing until homogeneous; and
   (vi) adding one or more cationic amino-functional emulsions and one or more silanol-functional siloxane emulsions and mixing until homogeneous, thereby obtain the composition of any one of embodiments 1-20.
22. A method of protecting a surface, wherein the method includes applying a coating of the composition of any one of embodiments 1-20 to a surface.
23. The method of embodiment 22, wherein the surface includes plastic, glass, vinyl, and rubber.
24. The method of embodiment 22 or 23, wherein the surface is a surface of a vehicle.
25. The method of any one of embodiments 22-24, wherein the surface is the surface of a bumper, rocker panel, weatherstripping cover, plastic backing of mirror, wheel, headlight, vinyl covers for vehicles, spare tire covers, or trims of door, wheel, and tailgate.
26. The method of any one of embodiments 22-25, wherein the coating remains on the surface for about 1 to 15 washes, about 3 to 15 washes, 6 to 12 washes, 8 to 13 washes, or about 10 to 13 washes.
27. The method of any one of embodiments 22-26, wherein the coating remains on the surface for 3 to 24 months, 3 to 18 months, 3 to 15 months, 6 to 15 months, or 6 to 12 months.
28. The method of any one of embodiments 22-27, wherein the surface has a higher gloss value, lower color depth value, and/or a higher contact angle than a surface that has not been applied with the composition.
29. The method of any one of embodiments 22-28, wherein the surface has ultraviolet radiation protection.
30. A kit including the composition of any one of embodiments 1-20 and an applicator for applying composition to a surface.
31. The kit of embodiment 30, wherein the applicator includes a sponge or microfiber cloth.

### Example

Representative embodiments of the present disclosure will now be described with reference to the following example that illustrate the principles and practice of the present disclosure.

TABLE 1
Example Formula 1

| | | Component |
|---|---|---|
| Component | Function | Quantity |
| DI Water | Diluent | 80.15 |
| LPA 210 | Solvent | 1.50 |
| NOVEMER EC-1 polymer | Rheology Modifier | 1.25 |
| XIAMETER PMX-200 | Silicone | 4.00 |
| (Silicone Fluid 1000 cSt) | | |
| ELEMENT14 PDMS 12.5K | Silicone | 7.58 |
| (Silicone Fluid | | |
| 12,500 cSt) | | |
| SEMTOL 500 | Mineral Oil | 1.00 |
| SILTECH E-4135 | Ceramic 35% Solids | 0.30 |
| | microemulsion of an amino | |
| | functional silicone and | |
| | nonionic emulsifiers | |
| DOWSIL HV 496 Emulsion | High molecular weight, | 2.00 |
| | silanol-functional | |
| | siloxane polymer emulsion | |
| XIAMETER MEM-8035 | Cationic, 35% active | 2.00 |
| | emulsion based on amino | |
| | functional silicone polymer. | |
| ACTICIDE B20 | Preservative | 0.22 |
| Total | | 100.00 |

The components of Example Formula 1, when combined, form Example Composition 1. Example Composition 1 was prepared by first completely sanitizing the tanks, raw material transfer/holding containers, pumps, holding tank, and piping to the filler before each batch. Blending of the raw materials of Example Formula 1 to form Example Composition 1 included adding the Deionized (DI) Water to a mixing tank, the specified amount of water was enough to cover all impellers of the agitator. Agitation during the batching process was enough to impart significant fluid movement, without excessive air entrainment. After the specified amount of water was added to the mixing tank, the LPA 210 was to the DI water in the mixing tank, and the solution was mixed until homogeneous, approximately 10 minutes. Next, the NOVEMER EC-1 was added to the mixing tank, and the solution was mixed until homogeneous, approximately 45 minutes. The agitation speed was adjusted as needed to achieve a fluid vortex of the solution with minimal splashing. Next, the SILTECH E-4135 was added to the mixing tank, and the solution was mixed for approximately 30 minutes, adjusting agitation speed as needed to form a fluid vortex with minimal splashing. The ACTICIDE B20 was then be added to the mixing tank, and the solution was mixed, adjusting the agitation speed as needed to form a vortex with minimal splashing. Next, the SEMTOL 500 and the XIAMETER PMX-200 Silicone Fluid 1000 cSt and ELEMENT14 PDMS 12.5K were added to the mixture. The mixture was then mixed until homogeneous, approximately 60 minutes, adjusting agitation speed as needed to form a vortex with minimal splashing. Finally, the silicone emulsions (e.g., DOWSIL HV 496 and XIAMETER MEM-8035) were be added to the mixture mixed until homogenous, approximately 60 minutes, adjusting agitation speed as needed.

1. A composition comprising:
at least two silicone fluids: a first silicone fluid and a second silicone fluid;
one or more silanol-functional siloxane emulsions;
one or more cationic amino-functional silicone emulsions;
one or more amino-functional siloxanes;
one or more mineral oils;
one or more rheology modifiers; and
one or more diluents; and
optionally:
one or more hydrocarbon solvents; and/or
one or more preservatives.

2. The composition of claim 1, wherein the composition comprises by total weight of the composition:
about 1% to 20% of the at least two silicone fluids;
about 1.0% to 5% of one or more silanol-functional siloxane emulsions;
about 1.0% to 5% of one or more cationic amino-functional silicone emulsions;
about 0.1% to 1.0% of one or more amino-functional siloxanes;
about 0.1% to 5% of the one or more mineral oils;
about 0.5% to 5% of the one or more rheology modifiers; and
about 75% to 95% of one or more diluents; and
optionally:
about 0.5% to 5% of the one or more hydrocarbon solvents; and/or
about 0.01% to 0.5% of the one or more preservatives.

3. The composition of claim 1, wherein the composition comprises by total weight of the composition:
about 4.00% of a first silicone fluid;
about 7.58% of a second silicone fluid;
about 2.0% of one or more silanol-functional siloxane emulsions;
about 2.0% of one or more cationic amino-functional silicone emulsions;
about 0.3% of one or more amino-functional siloxanes;
about 1.0% of the one or more mineral oils;
about 1.25% of the one or more rheology modifiers; and
about 80.15% of one or more diluents; and
optionally:
about 1.5% of the one or more hydrocarbon solvents; and/or
about 0.22% of the one or more preservatives.

4. The composition of claim 1, wherein the composition comprises by total weight of the composition: about at least 2.0% to 6.0% of the first silicone fluid and about at least 5% to 9.0% of the second silicone fluid.

5. The composition of claim 1, wherein the first silicone fluid has a viscosity of about 100 centistokes (cSt) to 1,500 cSt, 200 cSt to 1,200 cSt, 300 cSt to 1,200 cSt, or 300 cSt to 1,100 cSt, and the second silicone fluid has a viscosity of about 10,000 cSt to 15,000 cSt, 11,000 cSt to 14,500 cSt, 11,500 cSt to 14,000 cSt, or 12,000 cSt to 13,000 cSt.

6. The composition of claim 1, wherein the at least two silicone fluids comprise silicone oils having the formula:
RₙSiO_{(4-n)/2)m},
wherein:
n is 0 to 3;
m is 2 or greater; and
R is alkyl, alkylene, allyl, aryl, benzyl, phenyl, amine, amide, vinyl, fluoroalkyl, perfluoroalkane, carboxyester, or quaternary alkyl ammonium.

7. The composition of claim 1, wherein:
the at least two silicone fluids comprise silicone oils comprising polydialkylsiloxanes; and optionally wherein the polydialkylsiloxanes comprise polydimethylsiloxanes;
the one or more silanol-functional siloxane emulsions comprise a silanol-functional siloxane polymer, and optionally wherein the silanol-functional siloxane polymer is a high molecular weight polymer;
the one or more cationic amino-functional silicone emulsions comprise an amino-functional silicone polymer, and optionally, wherein the amino-functional silicone polymer comprises di-Me, polymers with 3-[(2-aminoethyl)amino]propyl silsesquioxanes, hydroxy-terminated;
the one or more amino-functional siloxanes comprises an amino-functional polydimethylsiloxane, and optionally, wherein the amino-functional polydimethylsiloxane is amodimethicone;
the one or more mineral oils comprise mineral synthetic oil and/or mineral oil obtained from petrochemicals;
the one or more rheology modifiers comprise acrylate and acrylamide copolymers;
the one or more hydrocarbon solvents comprise hydrotreated light petroleum distillates, alcohol hydrocarbon solvents, or a combination thereof;
the one or more hydrocarbon solvents comprise hydrotreated isoparaffins and naphthenics;
the one or more diluents comprise water, and optionally wherein the water is distilled water, deionized water, or reverse osmosis water; and/or
the one or more preservatives comprise dimethyl-dimethyl hydantoin (DMDMH), benzisothiazolinone (BIT), methylisothiazolinone (MIT), or methylchloroisothiazolinone (CMIT), iodopropyl butylcarbamate, or a combination thereof.

8. The composition of claim 1, wherein the composition comprises: silicone fluid of about 1,000 cSt; silicone fluid of about 12,500 cSt; high molecular weight silanol-functional siloxane polymer emulsion; a cationic amino-functional emulsion comprising di-Me, polymers with 3-[(2-aminoethyl)amino]propyl silsesquioxanes, hydroxy-terminated; amodimethicone; mineral oil obtained from petrochemicals; acrylate and acrylamide copolymers; and water; and optionally: a mixture of hydrotreated isoparaffins and naphthenics; and/or a preservative comprising BIT.

9. The composition of claim 1, wherein the composition comprises by total weight of the composition:
about 4.00% of a silicone fluid of about 1,000 cSt;
about 7.58% of a silicone fluid of about 12,500 cSt;
about 2.0% of a high molecular weight silanol-functional siloxane polymer emulsion;
about 2.0% of a cationic amino-functional emulsion comprising di-Me, polymers with 3 [(2-aminoethyl)amino]propyl silsesquioxanes, hydroxy-terminated;
about 0.3% of amodimethicone;
about 1.0% of mineral oil obtained from petrochemicals;
about 80.15% of water;
about 1.25% of acrylate and acrylamide copolymers;
about 1.5% of a mixture of hydrotreated isoparaffins and naphthenics; and
about 0.22% of preservative comprising BIT.

10. A method of preparing the composition of claim 1, wherein the method comprises:
(i) adding one or more hydrocarbon solvents to the one or more diluents that is mixing in a container to form a homogeneous solution;
(ii) adding one or more rheology modifiers to the solution and mixing until homogeneous;
(iii) adding one or more amino functional siloxanes and mixing;
(iv) adding one or more preservatives and mixing;
(v) adding one or more mineral oils and the at least two silicone fluids and mixing until homogeneous; and
(vi) adding one or more cationic amino-functional emulsions and one or more silanol-functional siloxane emulsions and mixing until homogeneous, thereby obtain the composition.

11. A method of protecting a surface, wherein the method comprises applying a coating of the composition of claim 1 to a surface.

12. The method of claim 11, wherein the surface comprises plastic, glass, vinyl, and rubber.

13. The method of claim 11, wherein the surface is a surface of a vehicle.

14. The method of claim 11, wherein the surface is the surface of a bumper, rocker panel, weatherstripping cover, plastic backing of mirror, wheel, headlight, vinyl covers for vehicles, spare tire covers, or trims of door, wheel, and tailgate.

15. The method of claim 11, wherein the coating remains on the surface for about 1 to 15 washes, about 3 to 15 washes, 6 to 12 washes, 8 to 13 washes, or about 10 to 13 washes.

16. The method of claim 11, wherein the coating remains on the surface for 3 to 24 months, 3 to 18 months, 3 to 15 months, 6 to 15 months, or 6 to 12 months.

17. The method of claim 11, wherein the surface has a higher gloss value, lower color depth value, and/or a higher contact angle than a surface that has not been applied with the composition.

18. The method of claim 11, wherein the surface has ultraviolet radiation protection.

19. A kit comprising the composition of claim 1 and an applicator for applying composition to a surface.

20. The kit of claim 19, wherein the applicator comprises a sponge or microfiber cloth.
